(19) United States
(12) Patent Application Publication
(10) Pub. No.: US 2022/0290633 A1
(43) Pub. Date: Sep. 15, 2022

(54) THRUST REVERSER COMPRISING AT LEAST ONE INITIATOR TO INITIATE THE CLOSING OF A MOBILE EXTERNAL STRUCTURE OF THIS REVERSER

(71) Applicant: SAFRAN NACELLES, Gonfreville-L'Orcher (FR)

(72) Inventors: Pierre Charles CARUEL, Moissy-Cramayel (FR); Fabien CHARLIAC, Moissy-Cramayel (FR); Benjamin BREBION, Moissy-Cramayel (FR); Thomas MARLAY, Moissy-Cramayel (FR); Fabien BRAVIN, Moissy-Cramayel (FR)

(73) Assignee: SAFRAN NACELLES, Gonfreville-L'Orcher (FR)

(21) Appl. No.: 17/632,761

(22) PCT Filed: Jul. 31, 2020
(86) PCT No.: PCT/FR2020/051417

§ 371 Date: Feb. 3, 2022

(30) Foreign Application Priority Data
Aug. 5, 2019 (FR) 1908981

(51) Int. Cl. F02K 1/76; F02K 1/70

(52) U.S. Cl. CPC F02K 1/763; F02K 1/70

(57) ABSTRACT

A thrust reverser for an aircraft propulsion unit, this reverser including a fixed structure and a mobile external structure able to move between a closed position and an open position so as to cause the reverser to transition respectively between a direct-jet configuration and a reverse-jet configuration. The reverser includes, on the one hand, one or more actuators configured to move the mobile external structure between the closed position and the open position. The reverser includes, on the other hand, at least one initiator configured to apply to the mobile external structure a force that initiates a closure travel in which the mobile external structure is moved from the open position towards the closed position.

### TECHNICAL FIELD

The invention relates to the field of thrust reversers for aircraft propulsion units. The invention relates more specifically to the mechanism for moving the mobile external structure of such a reverser.

### PRIOR ART

Generally speaking, a thrust reverser can be placed in a direct jet configuration, allowing the propulsion unit to generate thrust, and in a reverse jet—or thrust reverser—configuration wherein a portion of the gases circulating in the propulsion unit is redirected towards the front of the propulsion unit, thus generating a braking counter-thrust of the aircraft.

For this purpose, thrust reversers generally comprise a mobile external structure such as a sliding cowl or a pivoting door. In direct jet, the mobile external structure is in a closed position wherein it is configured to guide a flow of fluid through the propulsion unit, this flow fully contributing to the thrust. In reverse jet, the mobile external structure is in an open position wherein it releases a radial opening configured to discharge a portion of the fluid flow from the propulsion unit so as to generate the counter-thrust.

In a conventional reverser, for example that described in document WO 2011/064479 A1, the movement of the mobile external structure between the closed position and the open position is performed by actuators such as cylinders. These actuators are typically configured to exert on the mobile external structure either a pushing force to achieve the opening travel, that is to say to move the mobile external structure from the closed position to the open position, or a pulling force to achieve the closing travel, that is to say to move the mobile external structure from the open position to the closed position.

When the mobile external structure is in the open position, it is exposed to aerodynamic stresses that can generate a tilting torque tending to make it pivot. These stresses can thus lead to jamming of the mobile external structure in the open position and a phenomenon of chattering during the initiation of the closing travel.

These jamming and/or chattering phenomena, which are taken into account when sizing the actuators, can be amplified in the event of breakage or damage to one of the actuators.

### DESCRIPTION OF THE INVENTION

The invention aims to facilitate the closing of the mobile external structure of a thrust reverser, in particular in the event of this mobile external structure jamming in the open position.

To this end, the object of the invention is a thrust reverser for an aircraft propulsion unit, this thrust reverser comprising a fixed structure and a mobile external structure, this thrust reverser being configured to be placed in:
a direct jet configuration wherein the mobile external structure is in a closed position, the mobile external structure in the closed position being configured to guide a flow of fluid in the propulsion unit so as to generate a thrust,
a reverse jet configuration wherein the mobile external structure is in an open position, the mobile external structure in the open position releasing a radial opening capable of discharging a portion of said fluid flow from the propulsion unit so as to generate a counter-thrust.

This reverser comprises at least one actuator configured to move the mobile external structure between the closed position and the open position.

According to the invention, this reverser comprises at least one initiator, distinct from the at least one actuator, configured to exert on the mobile external structure a force to initiate a closing travel wherein the mobile external structure is moved from the open position to the closed position.

In other words, the reverser comprises on the one hand at least one actuator configured to perform an opening travel and at least a portion of a closing travel. During the opening travel, at least one actuator can move the mobile external structure from the open position to the closed position. During the closing travel, the at least one actuator can move the mobile external structure from the closed position—or from an intermediate position close to the closed position (see below)—to the open position. On the other hand, the reverser comprises at least one initiator, distinct from the at least one actuator, configured to initiate or contribute to the initiation of the closing travel by exerting on the mobile external structure an impulsive starting force, that is to say a transient force exerted on the mobile external structure during an initial phase of the closing travel.

The invention thus allows to mitigate or limit the risks of jamming and/or chattering generated by frictional forces between the fixed structure and the mobile external structure. These jamming and/or chattering phenomena can typically result from a breakage or deterioration of one of the actuators when the reverser comprises a plurality of actuators, or from abnormal wear of the coatings of the guide rails leading to an increase in friction, or an asymmetric or non-uniform distribution of the at least one actuator, for example when a single actuator is provided to move the mobile external structure between the closed position and the open position. Under such conditions, the resultant of the forces exerted on the mobile external structure in the open position can cause the mobile external structure to pivot, the latter typically being cantilevered when the reverser is in the reverse jet configuration.

By initiating the closing travel, the at least one initiator allows to loosen the mobile external structure by realigning it, and to reduce the phenomenon of chattering.

The initiator also allows to reduce the moment, applied to the fixed structure, which tends to deform it and create asymmetric reactions in the rails as well as excessive friction liable to make the movement irreversible.

This results in facilitating the closing of the mobile external structure.

For this purpose, the at least one initiator can typically be disposed so as to exert the initiation force on at least one corresponding portion of the mobile external structure capable of being axially offset downstream relative to other portions of the mobile external structure, the downstream being defined relative to a direction of fluid flow exerting an aerodynamic constraint on this mobile external structure, or more generally on at least one corresponding portion of the mobile external structure on which such an initiation force is capable of counterbalancing the aerodynamic forces which can be applied to the mobile external structure in an asymmetric or non-uniformly distributed manner.

The invention also allows to reduce the dimensions of the at least one actuator and therefore its mass, the required closing force being less given the initiation of the closing travel produced by the at least one initiator. It is thus possible to reduce the overall mass of the reverser.

The at least one actuator and the at least one initiator can act simultaneously during the initial phase of the closing travel.

However, it is preferred to only involve at least one initiator during the initial phase of the closing travel, and to use at least one actuator during a subsequent consecutive phase.

In one embodiment, the at least one initiator may be integral with one of the fixed structure and the mobile external structure, the at least one initiator being able to be configured to:
cooperate with the other of the fixed structure and the mobile external structure during an initial phase of the closing travel, the at least one initiator being configured to exert said initiation force during this initial phase,
be separated from the other of the fixed structure and the mobile external structure during a subsequent phase of the closing travel of the mobile external structure.

Preferably, the at least one initiator can form an end-of-opening travel stop limiting the movement of the mobile external structure in the open position.

Such a stop formed by at least one initiator allows to retain the mobile external structure and to take up the forces exerted thereon when the reverser is in reverse jet, which allows in particular to reduce the butting of the mobile external structure in the open position.

In one embodiment, the at least one initiator can be configured to dampen the mobile external structure as it moves to the open position.

Such damping allows to limit the dynamic impact of the mobile external structure on the fixed structure. It is thus possible to reduce the dimensions and therefore the mass of the impact elements constituted, for example, by said stop formed by at least one initiator.

The stop and damping features can be combined such that the at least one initiator in one embodiment forms an elastic stop.

In one embodiment, the at least one initiator can be configured to accumulate mechanical energy when the mobile external structure is moved to the open position and to restore the mechanical energy thus accumulated so as to exert said initiation force.

For this purpose, at least one initiator may for example comprise at least one spring configured to accumulate and restore said mechanical energy.

In one embodiment, at least one initiator may comprise at least one cylinder configured to exert said initiation force.

In other words, the at least one initiator may comprise at least one passive member such as a spring or active member such as a cylinder, it being understood that these embodiments can be combined. For example, the reverser may comprise one or more initiators each comprising a spring and one or more other initiators each comprising a cylinder.

In one embodiment, preferably when the reverser comprises a single actuator, the actuator and the initiator, or the actuator and one of the initiators when the reverser comprises several initiators, can be diametrically opposite to each other.

More generally, the reverser may comprise an actuator and an initiator as described above, wherein this actuator and this initiator can be diametrically opposite to each other.

In one embodiment, the mobile external structure may comprise a fairing and at least one member for connecting the fairing with the fixed structure, the at least one connecting member of the mobile external structure cooperating with at least one corresponding connecting member of the fixed structure so as to guide the movement of the mobile external structure between the closed position and the open position in an axial direction, the mobile external structure being configured to allow rotational movement of the fairing relative to the at least one connecting member of this mobile external structure about an axis perpendicular to said axial direction, or oblique relative to this axial direction.

Such a mobile external structure allows angular displacement of its fairing relative to the fixed structure, which allows to improve the movement of the mobile external structure between the open and closed positions given the radial forces to which the fairing can be subjected.

The object of the invention is also an aircraft propulsion unit, this propulsion unit comprising a thrust reverser as defined above.

The object of the invention is also a method for closing a mobile external structure of a thrust reverser as defined above, this method comprising:
a step of initiating a closing travel of the mobile external structure during which the at least one initiator exerts said initiation force on the mobile external structure,
a step of actuating at least one actuator so as to move the mobile external structure to the closed position.

Other advantages and features of the invention will become apparent upon reading the detailed, non-limiting description which follows.

### BRIEF DESCRIPTION OF THE DRAWINGS

The following detailed description refers to the appended drawings wherein:

FIG. 1 is a schematic axial sectional view of an aircraft propulsion unit in accordance with the invention, this propulsion unit comprising a double-body and bypass turbojet engine;

FIG. 2 is a schematic axial sectional half-view of a thrust reverser in accordance with the invention, in a direct jet configuration;

FIG. 3 is a schematic axial sectional half-view of the thrust reverser of FIG. 2, in a reverse jet configuration;

FIG. 4 is a schematic perspective view of a portion of a thrust reverser in accordance with the invention, showing a mechanism for guiding the mobile external structure of this reverser;

FIG. 5 is an enlargement of a portion of FIG. 4, centred on said guide mechanism;

FIG. 6 is a schematic perspective view of a propulsion unit of the prior art, this propulsion unit comprising a thrust reverser whose mobile external structure is shown in a tilting position;

FIG. 7 is a schematic axial sectional view a portion of a thrust reverser in accordance with the invention, this reverser comprising a passive initiator and a mobile external structure in an open position;

FIG. 8 is a schematic perspective view of the reverser of FIG. 7, more specifically showing a guide mechanism of the mobile external structure;

The FIG. 9 is a schematic view of a thrust reverser in accordance with the invention, this reverser comprising a passive initiator and a mobile external structure in a closed position;

FIG. 10 is a schematic view of the reverser of FIG. 9, the mobile external structure being in an intermediate position;

FIG. 11 is a schematic view of the reverser of FIG. 9, the mobile external structure being in the open position;

FIG. 12 is a schematic view of a thrust reverser in accordance with the invention, which differs from that of FIG. 9 in that the mobile external structure comprises a fairing articulated relative to a connecting member of this mobile external structure with a fixed structure of the reverser;

FIG. 13 is a schematic view of a thrust reverser in accordance with the invention, this reverser comprising an active initiator and a mobile external structure in a closed position;

FIG. 14 is a schematic view of the reverser of FIG. 13, the mobile external structure being in an intermediate position;

FIG. 15 is a schematic view of the reverser of FIG. 13, the mobile external structure being in an open position.

### DETAILED DESCRIPTION OF EMBODIMENTS

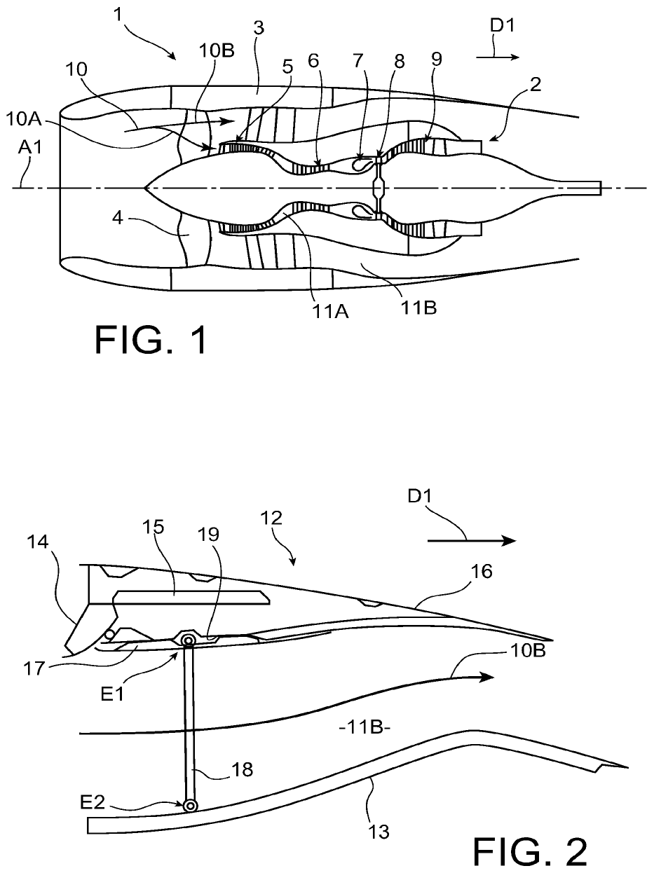

FIG. 1 shows an aircraft propulsion unit 1 comprising a turbomachine 2 faired by a nacelle 3. In this example, the turbomachine 2 is a double-body and bypass turbojet engine.

Subsequently, the terms “upstream”, “downstream”, “front” and “rear” are defined relative to a sense D1 of gas flow through the propulsion unit 1 when the latter is propelled.

The turbojet engine 2 has a longitudinal central axis A1 around which its various components extend, in this case, from upstream to downstream of the turbojet engine 2, a fan 4, a low pressure compressor 5, a high pressure compressor 6, a combustion chamber 7, a high pressure turbine 8 and a low pressure turbine 9. The compressors 5 and 6, the combustion chamber 7 and the turbines 8 and 9 form a gas generator.

Conventionally, during the operation of such a turbojet engine 2, an air flow 10 enters the propulsion unit 1 through an air inlet upstream of the nacelle 3, passes through the fan 4 and then splits into a central primary flow 10A and a secondary flow 10B. The primary flow 10A flows in a primary flow path 11A for the circulation of gases passing through the gas generator. The secondary flow 10B, in turn, flows in a secondary flow path 11B surrounding the gas generator and delimited radially outwards by the nacelle 3.

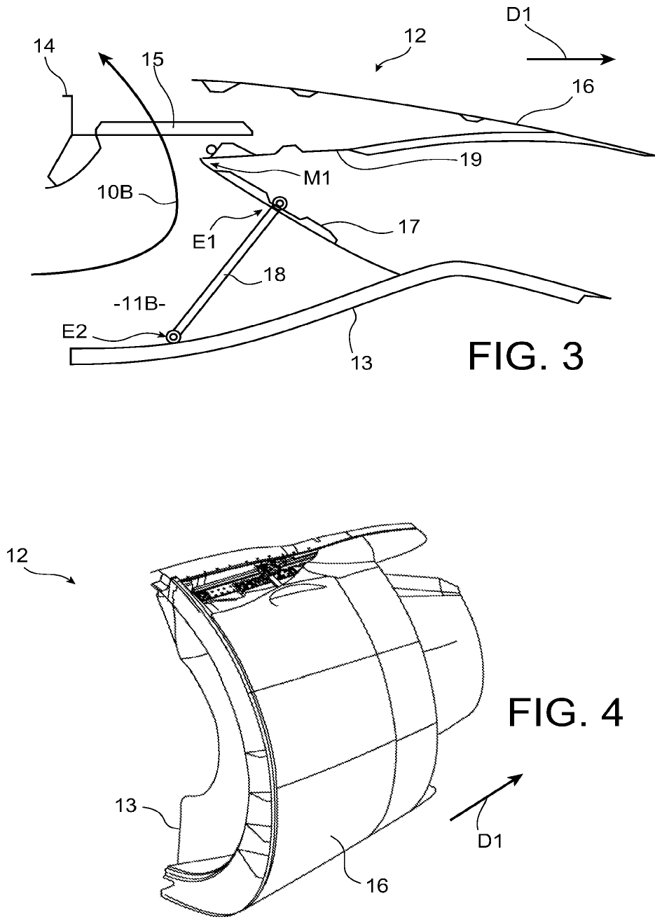

The invention relates to a thrust reverser 12 as illustrated in FIGS. 2 and 3, or in FIG. 4, for reversing the thrust generated by such a propulsion unit 1.

With reference to FIGS. 2 and 3, the thrust reverser 12 comprises, on the one hand, elements fixed relative to a stator of the turbojet engine 2, among which a fixed internal structure 13, a front frame 14 and cascades 15 carried by the front frame 14.

This thrust reverser 12 also comprises mobile elements relative to the aforementioned fixed elements, among which a mobile external structure 16 forming in this example a sliding mobile cowl, shutter flaps 17 and tie rods 18. These mobile elements allow to modify the configuration of the thrust reverser 12.

FIG. 2 shows the thrust reverser 12 in a direct jet configuration. In this configuration, the mobile cowl 16 is in a closed position wherein it bears axially against the front frame 14 while covering the cascades 15.

In direct jet, the mobile cowl 16 and the fixed internal structure 13 radially delimit therebetween a downstream portion of the secondary flow path 11B.

The shutter flaps 17 are in a retracted position wherein they are housed in a cavity 19 of the mobile cowl 16 so as not to close the secondary flow path 11B.

Thus, in a direct jet, the thrust reverser 12 allows to channel the secondary flow 10B towards the rear of the propulsion unit 1 so that this secondary flow 10B fully contributes to the propulsion of the aircraft.

FIG. 3 shows the thrust reverser 12 in a counter-thrust configuration, also referred to as a reverse jet. In this configuration, the mobile cowl 16 is in an open position wherein it releases a radial opening constituted in this example by openings of the cascades 15. Indeed, the axial translation of the mobile cowl 16, towards the rear of the propulsion unit 1 relative to the front frame 14, uncovers the cascades 15 which are integral with the front frame 14.

The sliding of the mobile cowl 16 from the closed position (FIG. 2) to the closed position (FIG. 3) causes deployment of the shutter flaps 17 in the secondary flow path 11B. For this purpose, the shutter flaps 17 are articulated to the mobile cowl 16 at an articulation point M1 and each of the tie rods 18 is connected at a first end E1 to a respective shutter flap 17 and at a second end E2 to the fixed internal structure 13.

In reverse jet, the shutter flaps 17 are thus in a deployed position so as to deflect towards the cascades 15 a portion representing in this example substantially all of the secondary flow 10B (see FIG. 3).

In a manner known per se, the cascades 15 comprise a blading allowing to direct the secondary flow 10B passing through these cascades 15 towards the front of the propulsion unit 1.

In this thrust reversal configuration, the secondary flow 10B thus generates a braking counter-thrust of the aircraft.

To modify the configuration of the thrust reverser 12, the latter comprises actuators such as cylinders (not shown) configured to move the mobile cowl 16 between the closed position and the open position. These cylinders are in this example carried by the front frame 14 and are connected to the mobile cowl 16 so as to exert on the latter a pushing or pulling force, to move it respectively from upstream to downstream or from downstream to upstream.

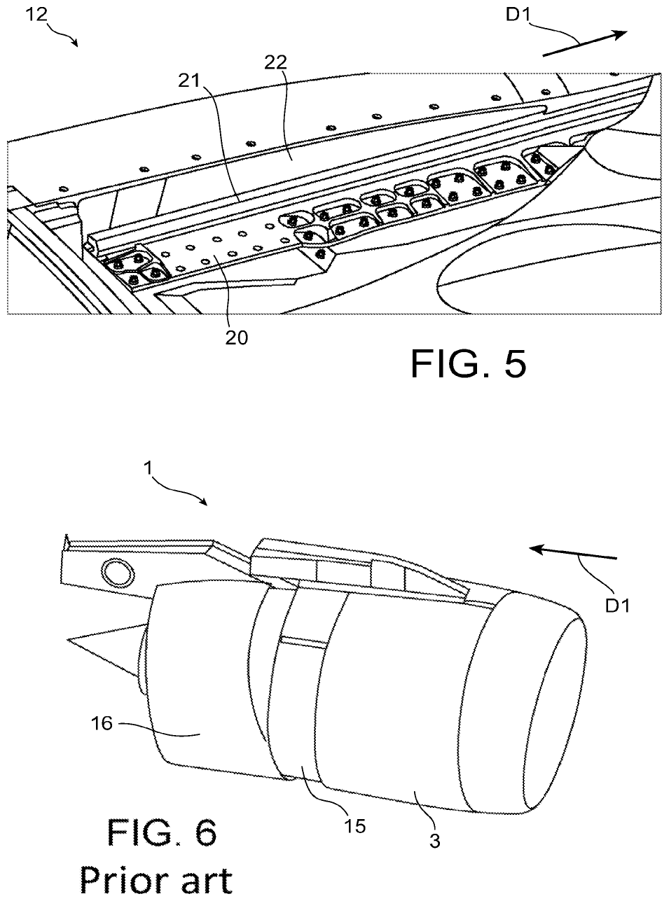

In the embodiment of FIGS. 4 and 5, the guiding of the mobile cowl 16 during its movement between the closed and open positions is performed by a slide 20, integral with the mobile cowl 16, this slide 20 cooperating with a rail 21 carried by a support structure 22 constituting one of said fixed elements of the reverser 12.

In the open position, the mobile cowl 16, cantilevered on the rail 21, is axially retained by the actuators.

In the event of an actuator breaking, for example, and the absence of a complementary mechanism allowing the mobile cowl 16 to be axially retained in the open position, there is a risk of this mobile cowl 16 tilting under the action of the aerodynamic stresses to which it is subjected. In such a case, the mobile cowl 16 may assume a tilting position as illustrated in FIG. 6, the latter showing a propulsion unit 1 of the prior art without a complementary axial retention mechanism.

In such a tilting position, the mobile cowl 16 can be jammed and thus hinder its movement towards the closed position, and can generate a chatter phenomenon during the initiation of the closing travel under the action of the pulling exerted by the other actuator(s) which is/are still operational, in particular in the case where the moment applied to the cowl results in radial forces on the rails and in an irreversible increase in friction.

To overcome such drawbacks, the reverser 12 of the invention comprises at least one initiator 23 configured to exert on the mobile cowl 16 a force to initiate the closing travel.

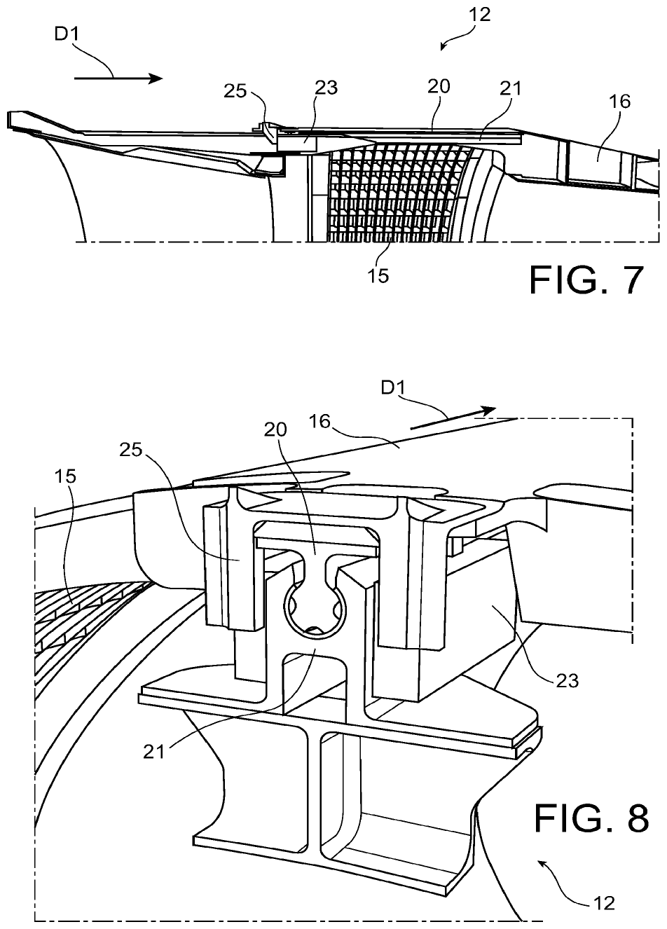

FIGS. 7 to 12 relate to a first type of embodiment wherein at least one initiator 23 is passive.

FIGS. 13 to 15 relate to a second type of embodiment wherein the at least one initiator 23 is active.

The following description relates to a single initiator 23. The resulting principles can of course be applied to several initiators of the same reverser 12.

With reference to FIG. 9, an initiator 23 such as a spring is interposed between the mobile cowl 16 and a fixed structure 24 of the reverser 12.

In this example, the initiator 23 is fixed to the fixed structure 24 of the reverser 12, more specifically to the support structure 22 carrying the rail 21 (see FIG. 5 and corresponding description above).

In the closed position (FIG. 9), the mobile cowl 16 is moved away from the initiator 23 and is therefore not in contact with this initiator 23. In other words, the initiator 23 is separated from the mobile cowl 16 in the closed position.

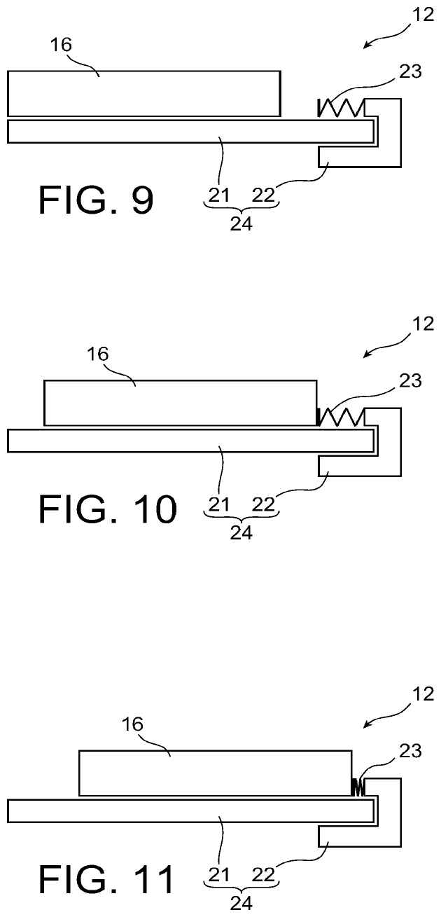

When the actuators move the mobile cowl 16 from the closed position to the open position, the mobile cowl 16 reaches an intermediate position during this opening travel wherein one end—downstream end in this example—of the mobile cowl 16 contacts the initiator 23 (FIG. 10).

By continuing its opening travel to the open position illustrated in FIG. 11, the mobile cowl 16 cooperates with the initiator 23 as described below.

The initiator 23 being in this example a spring, the latter dampens the mobile cowl 16 in an end phase of the opening travel, in this case from the intermediate position (FIG. 10) to the open position (FIG. 11) of the mobile cowl 16.

In addition, during this end phase of the opening travel, the initiator 23 accumulates mechanical energy by being compressed between the mobile cowl 16 and the fixed structure 24.

It follows from the above that the initiator 23 forms an end-of-opening travel stop limiting the movement of the mobile cowl 16 when the latter reaches the open position.

The actuators are configured to keep the mobile cowl 16 in the open position for the required thrust reversal duration.

To return the reverser 12 to the direct jet configuration, a control unit (not shown) is configured to control the actuators so as to move the mobile cowl 16 from the open position (FIG. 11) to the closed position (FIG. 9).

For example, during an initial phase of the closing travel, the actuators can be controlled in such a way that the mechanical energy accumulated by the initiator 23 is restored so as to produce said initiation force and so that this initiation force causes as such a movement of the mobile cowl 16 from the open position (FIG. 11) to the intermediate position (FIG. 10).

At the end of this initial phase of the closing travel, the actuators can be controlled to move the mobile cowl 16 from the intermediate position (FIG. 10) to the closed position (FIG. 9).

The initiator 23 is therefore configured to cooperate with the mobile cowl 16 during the initial phase of the closing travel, by exerting an initiation force during this initial phase.

The initiator 23 is further configured to be separated from the mobile cowl 16 during a subsequent phase of the closing travel.

FIGS. 7 and 8 show an example of a reverser provided with a passive initiator 23 as described above. In this example, the slide 20 integral with the mobile cowl 16 forms an upstream stop 25 which cooperates, at the end of the opening travel and at the start of the closing travel, with the initiator 23, the latter being integral with the rail 21 carried by the support structure 22 of the fixed structure 24 of the reverser 12.

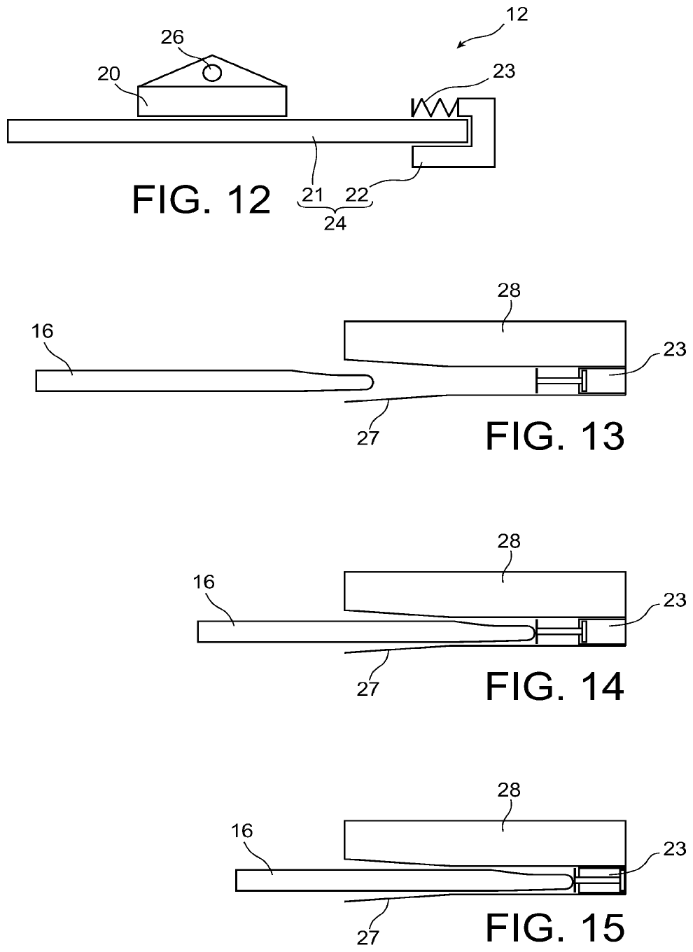

In the embodiment of FIG. 12, provision is made to allow angular movement of the mobile cowl 16 relative to the fixed structure 24 of the reverser 12. For this purpose, the mobile cowl 16 comprises, on the one hand, a slide 20 of the type described above, and on the other hand, a portion forming a fairing connected to the slide 20 in a pivot connection 26. Such a pivot connection 26 allows rotational movement of the fairing relative to the slide 20 about an axis which is in this example perpendicular to the direction of movement of the mobile cowl 16 as well as to the longitudinal central axis A1.

In this example, the slide 20 forms a member for connecting the fairing of the mobile cowl 16 with the fixed structure 24, and conversely the rail 21 forms a corresponding member for connecting the fixed structure 24 with the mobile cowl 16, so that the cooperation of the slide 20 and the rail 21 ensures the guiding of the mobile cowl 16 between the closed and open positions while allowing an angular displacement of its fairing relative to the fixed structure 24.

The embodiment of FIGS. 13 to 15 is described below, which differs in particular from that of FIGS. 9 to 11 in that the initiator 23 is an active member of the cylinder type.

With reference to FIG. 13, the fixed structure of the reverser 12 comprises a rail 28 provided with an opening 27 configured to receive a portion of the mobile cowl 16, at least in certain positions of the mobile cowl 16.

In this example, the initiator 23 is fixed to the rail 28 of the reverser 12, while being housed in a bottom of the opening 27.

In the closed position (FIG. 13), the mobile cowl 16 is moved away from the initiator 23 and is therefore not in contact with this initiator 23. In other words, the initiator 23 is separated from the mobile cowl 16 in the closed position.

When the actuators move the mobile cowl 16 from the closed position to the open position, the mobile cowl 16 reaches an intermediate position during this opening travel wherein one end of this cowl 16 contacts the initiator 23 (FIG. 14).

By continuing the opening travel to the open position illustrated in FIG. 15, the initiator 23 cooperates with the mobile cowl 16 as described below.

The initiator 23 is in this example a cylinder allowing to dampen the mobile cowl 16 in an end phase of the opening travel, in this case from the intermediate position (FIG. 14) to the open position (FIG. 15) of the mobile cowl 16. The damping results from the progressive discharge of a fluid such as a gas contained in the chamber of the cylinder 23, under the action of the relative movement of the mobile cowl 16 and of the rail 28.

When the mobile cowl 16 reaches the open position, the chamber no longer contains any fluid, and the initiator 23 thus forms an end-of-opening travel stop limiting the movement of the mobile cowl 16.

In this example, the initiator 23 does not accumulate mechanical energy during this end phase of the opening travel, the increase in pressure in the chamber requiring fluid injection control.

To return the reverser 12 in the direct jet configuration, the actuators and the initiator 23 are respectively controlled by a control unit so as to move the mobile cowl 16 from the open position (FIG. 15) to the closed position (FIG. 13).

For example, during an initial phase of the closing travel, the initiator 23 is controlled to produce the initiation force so as to move the mobile cowl 16 from the open position (FIG. 15) to the intermediate position (FIG. 14).

At the end of this initial phase, the actuators can be controlled to move the mobile cowl 16 from the intermediate position (FIG. 14) to the closed position (FIG. 13).

In this example, the initiator 23 is therefore configured to cooperate with the mobile cowl 16 during the initial phase of the closing travel by exerting an initiation force during this initial phase. The initiator 23 is further configured to be separate from the mobile cowl 16 during a subsequent phase of the closing travel.

In one embodiment, the control unit can be programmed to control one or more actuators and/or at least one initiator 23 depending on the actual configuration of the mobile cowl 16, which can be evaluated using a detection means. Such a servo control allows to optimise the closing of the mobile cowl 16.

In each of the embodiments described above, a method is implemented for closing the mobile cowl 16 wherein a step of initiating the closing travel and a step, preferably a consecutive step, of actuating the actuators.

During the initiation step, the initiator 23 exerts an initiation force on the mobile cowl 16 so as to move the mobile cowl 16 from the open position to an intermediate position located between the open position and the closed position, or possibly so as to correctly reposition the mobile cowl 16 in the open position.

During the actuation step, the actuators move the mobile cowl 16 to the closed position at least from said intermediate position.

Of course, these examples are in no way limiting, the invention being particularly applicable to other types of thrust reverser architecture, such as a reverser with pivoting doors.

1. A thrust reverser for an aircraft propulsion unit, said reverser comprising a fixed structure and a mobile external structure, said reverser being configured to be placed in:
a direct jet configuration wherein the mobile external structure is in a closed position, the mobile external structure in the closed position being configured to guide a flow of fluid in the propulsion unit so as to generate a thrust,
a reverse jet configuration wherein the mobile external structure is in an open position, the mobile external structure in the open position releasing a radial opening capable of discharging a portion of said fluid flow from the propulsion unit so as to generate a counter-thrust,
said reverser comprising at least one actuator configured to move the mobile external structure between the closed position and the open position, this wherein said reverser comprises at least one initiator, distinct from the at least one actuator, configured to exert on the mobile external structure a force to initiate a closing travel wherein the mobile external structure is moved from the open position to the closed position.

2. The reverser according to claim 1, wherein the at least one initiator is integral with one of the fixed structure and the mobile external structure, the at least one initiator being configured to:
cooperate with the other of the fixed structure and the mobile external structure during an initial phase of the closing travel, the at least one initiator being configured to exert said initiation force during said initial phase,
be separated from the other of the fixed structure and the mobile external structure during a subsequent phase of the closing travel of the mobile external structure.

3. The reverser according to claim 1, wherein the at least one initiator forms an end-of-opening travel stop limiting the movement of the mobile external structure in the open position.

4. The reverser according to claim 1, wherein the at least one initiator is configured to dampen the mobile external structure as it moves to the open position.

5. The reverser according to claim 1, wherein the at least one initiator is configured to accumulate mechanical energy when the mobile external structure is moved to the open position and to restore the mechanical energy thus accumulated so as to exert said initiation force.

6. The reverser according to claim 5, wherein the at least one initiator comprises at least one spring configured to accumulate and restore said mechanical energy.

7. The reverser according to claim 1, wherein the at least one initiator comprises at least one cylinder configured to exert said initiation force.

8. The reverser according to claim 1, wherein the mobile external structure comprises a fairing and at least one member for connecting the fairing with the fixed structure, the at least one connecting member of the mobile external structure cooperating with at least one corresponding connecting member of the fixed structure so as to guide the movement of the mobile external structure between the closed position and the open position in an axial direction, the mobile external structure being configured to allow rotational movement of the fairing relative to the at least one connecting member of said mobile external structure about an axis perpendicular to said axial direction.

9. An aircraft propulsion unit, said propulsion unit comprising a thrust reverser according to claim 1.

10. A method for closing a mobile external structure of a thrust reverser according to claim 1, said method comprising:
a step of initiating a closing travel of the mobile external structure during which the at least one initiator exerts said initiation force on the mobile external structure,
a step of actuating at least one actuator so as to move the mobile external structure to the closed position.
